(19) United States
(12) Patent Application Publication
(10) Pub. No.: US 2021/0069723 A1
(43) Pub. Date: Mar. 11, 2021

(54) CUTTERHEAD ASSEMBLY OF BRANCH GRINDER

(71) Applicant: Zhejiang Yaofeng Power Technology Co., Ltd., Shaoxing City (CN)

(72) Inventors: Changrong YI, Shaoxing City (CN); Xiang CHEN, Shaoxing City (CN); Rutang XIE, Shaoxing City (CN); Jianxiong ZHU, Shaoxing City (CN)

(21) Appl. No.: 17/017,007

(22) Filed: Sep. 10, 2020

(30) Foreign Application Priority Data
Sep. 10, 2019 (CN) 201921494637.5

(51) Int. Cl. B02C 18/18; B27L 11/00; A01G 3/08

(52) U.S. Cl. CPC B02C 18/18; B02C 2201/066; A01G 3/08; B27L 11/005

(57) ABSTRACT

The disclosure discloses a cutterhead assembly of a branch grinder, including a cutterhead body, a center shaft disposed in a center of the cutterhead body and at least two installing shafts circumferentially distributed by using the center shaft as an axis, each of the at least two installing shafts is successively provided with a limiting plate, a first blade, a first bush, a second blade and a second bush from top to bottom, the first blade and the second blade are in clearance fit with a corresponding installing shaft in the at least two installing shafts, a center of the limiting plate is positioned at an upper end of the center shaft and a gap is kept between the limiting plate and an upper end of the first blade, an outer end of the limiting plate is stretched into the installing shafts and fixed, through the above installation, the first blade and the second blade can be completely rotated in 360 degrees relative to the installing shafts, in a circumferential rotating process of the blade, shredded wood can be taken out from the center of the cutterhead body, and a problem, that material blockage is caused to affect a cutting effect of the cutterhead assembly due to the material is stacked in the center of the cutterhead body 1, is avoided.

### TECHNICAL FIELD

The disclosure relates to a technical field of forestry machinery, and in particular to a cutterhead assembly of a branch grinder.

### BACKGROUND

A branch grinder is a common device in forestry machinery, and it is often used to break residual branches and twigs of trees. A core component of the branch grinder is a cutterhead, and a quality of the cutterhead determines a level of breaking efficiency. A blade of an existing cutterhead assembly may only be circumferentially rotated around a part of a rotating column (not completely rotate in 360 degrees), and it causes that broken wood is easily stacked in a center of a cutterhead body. When the broken wood is stacked to a certain extent, it inevitably causes that the cutterhead assembly fails to work, and then the branch grinder needs to be disassembled for cleaning, so it causes that the branch grinder is lower in working efficiency.

### SUMMARY

Some embodiments of the disclosure provide a cutterhead assembly of which a blade can be completely rotated in 360 degrees, and in a circumferential rotating process of the blade, shredded wood can be taken out from a center of a cutterhead body.

The above technical purpose of an embodiment of the disclosure is achieved by the following technical solutions: a cutterhead assembly of a branch grinder, including a cutterhead body, a center shaft disposed in a center of the cutterhead body and at least two installing shafts circumferentially distributed by using the center shaft as an axis, each of the at least two installing shafts is successively provided with a limiting plate, a first blade, a first bush, a second blade and a second bush from top to bottom, the first blade and the second blade are in clearance fit with a corresponding installing shaft in the at least two installing shafts, and the first blade and the second blade can be rotated in 360 degrees around the corresponding installing shaft, the limiting plate is positioned at an upper end of the center shaft and there is a gap between the limiting plate and an upper end of the first blade, and an outer end of the limiting plate is stretched into the installing shafts and fixed.

In an exemplary embodiment, an end, away from the corresponding installing shaft, of the first blade is downwards inclined disposed.

In an exemplary embodiment, an end, away from the corresponding installing shaft, of the second blade is downwards inclined disposed.

In an exemplary embodiment, the cutterhead assembly of the branch grinder further includes a third blade detachably installed, the third blade is positioned between the limiting plate and a locking nut, and an end, stretched out of the limiting plate, of the third blade is upwards inclined disposed.

In an exemplary embodiment, the third blade and the first blade are staggered disposition.

In an exemplary embodiment, the cutterhead body is provided with a plurality of baffles which are radially disposed, and at least one baffle in the plurality of baffles is disposed between adjacent installing shafts.

In an exemplary embodiment, a lower end of each of the plurality of baffles is provided with two convex ribs which are disposed at intervals, the cutterhead body is provided with rectangular grooves cooperated with the two convex ribs.

In an exemplary embodiment, a fourth blade is disposed at a lower end of the cutterhead body, the cutterhead body is provided with a strip-shaped groove, and the strip-shaped groove is disposed corresponding to a cutting notch of the fourth blade.

In an exemplary embodiment, a flange is limit-installed in the center shaft, an upper end of the flange is provided with a step aligned to the upper end of the center shaft, and the step is upwards protruded and provided with a positioning convex ring cooperatively installed with a center of the limiting plate.

In an exemplary embodiment a shaft hole is disposed in the center shaft, and the shaft hole is provided with a key groove.

In conclusion, some embodiments of the disclosure have the following beneficial effects.

Based on the cutterhead assembly of the branch grinder, there is the gap between the limiting plate and the upper end of the first blade, the first blade and the second blade are in clearance fit with the corresponding installing shaft so that the first blade and the second blade can be circumferentially rotated in 360 degrees relative to the installing shaft, through the above installation, in a circumferential rotating process of the first blade and the second blade, a shredded material can be taken out from the center of the cutterhead body, and a problem that material blockage is caused to affect a cutting effect of the cutterhead assembly due to the material is stacked in the center of the cutterhead body 1 is avoided; an end, relative to the corresponding installing shaft, of the first blade is downwards inclined installed, so that enough space is kept between the first blade and a housing, and the material is adequately cut by the first blade, the third blade and the first blade are staggered arranged, so that a cutting gradation of the cutterhead assembly is distinct, the material is cut in different directions, the material is more uniformly cut and the effect is better; and the third blade is detachably installed with the limiting plate, so the third blade damaged is conveniently replaced.

### BRIEF DESCRIPTION OF THE DRAWINGS

FIG. 1 illustrates an overall structure schematic diagram of an embodiment of the disclosure;

FIG. 2 illustrates a first perspective section view of an embodiment of the disclosure;

FIG. 3 illustrates a second perspective section view of an embodiment of the disclosure;

FIG. 4 illustrates an exploded view of an embodiment of the disclosure;

FIG. 5 illustrates a bottom view of an embodiment of the disclosure; and

FIG. 6 illustrates a structure schematic diagram of a baffle of an embodiment of the disclosure.

In the drawings: 1, cutterhead body; 11, installing hole; 12, rectangular groove; 13, fourth blade; 14, strip-shaped groove; 15, contacting portion; 2. center shaft; 21. shaft hole; 22, key groove; 3, installing shaft; 31, first blade; 32, first bush; 33, second blade; 34, second bush; 35, abutting portion; 351, inner hexagonal groove; 4, limiting plate; 41, locking nut; 42, third blade; 5, housing; 6, flange; 61, step; 62, positioning convex ring; 7, baffle; and 71, convex rib.

### DETAILED DESCRIPTION OF THE EMBODIMENTS

Some embodiments of the disclosure are further described below in combination with the drawings.

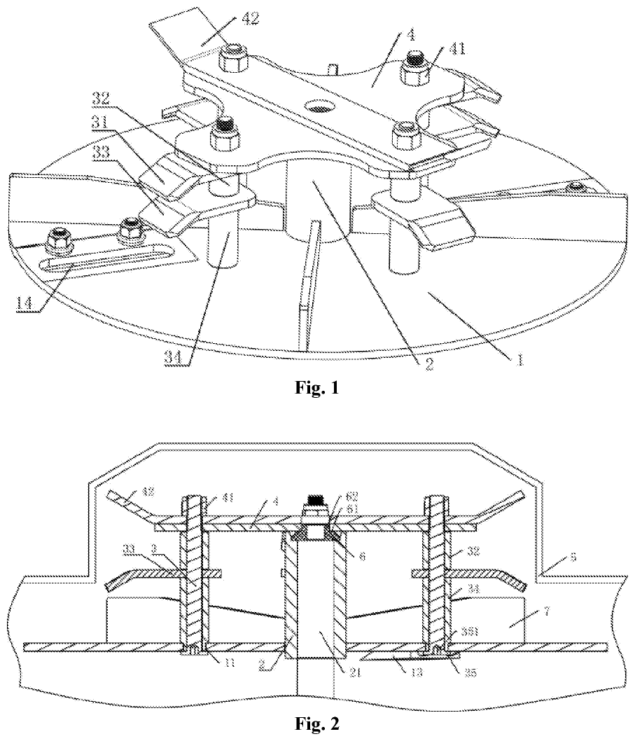

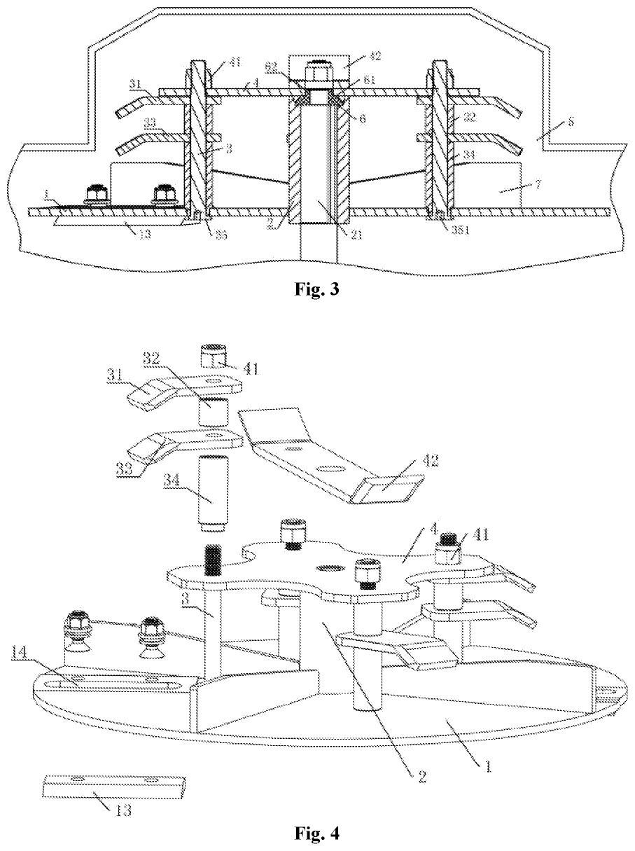

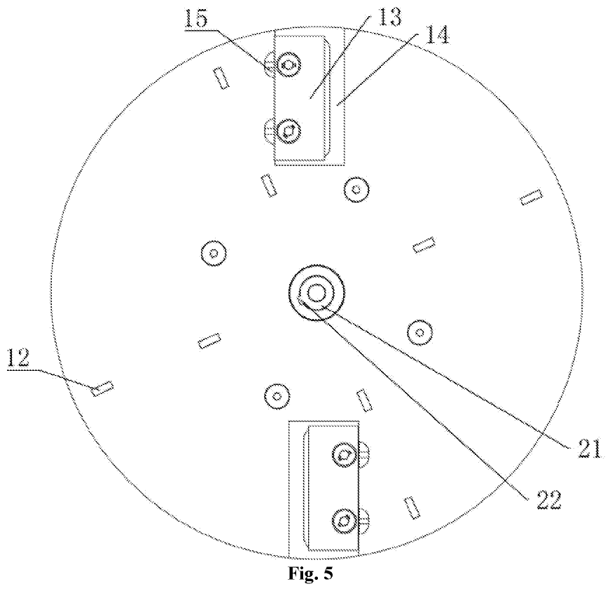

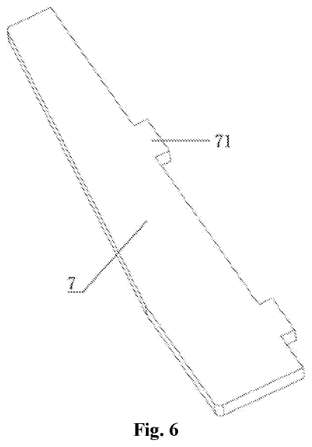

As shown in FIGS. 1-6, some embodiments of a disclosure provide a cutterhead assembly of a branch grinder. The cutterhead assembly of the branch grinder includes a cutterhead body 1, a center shaft 2 disposed in a center of the cutterhead body 1 and at least two installing shafts 3 circumferentially distributed by using the center shaft 2 as an axis. An upper ends of the at least two installing shafts 3 are provided with threads, each of the at least two installing shafts 3 is successively provided with a limiting plate 4, a first blade 31, a first bush 32, a second blade 33 and a second bush 34 from top to bottom, the first blade 31 and the second blade 33 are in clearance fit with the corresponding installing shaft 3, and the first blade 31 and the second blade 33 can be circumferentially rotated in 360 degrees relative to the corresponding installing shaft 3, a center of the limiting plate 4 is positioned at an upper end of the center shaft 2 and there is a gap between the limiting plate 4 and an upper end of the first blade 31, and an outer end of the limiting plate 4 is stretched into the installing shafts 3 and locked by a locking nut 41, the locking nut 41 in an embodiment of the disclosure is a self-locking nut, and an outer end of the cutterhead assembly is provided with a housing 5 for covering the cutterhead assembly.

The cutterhead body 1 is circumferentially provided with an installing hole 11, a bottom end of the each of the at least two installing shafts 3 is provided with an abutting portion 35, and a lower end of the second bush 34 is locked in the installing hole 11 and abutted against an upper end of the cutterhead body 1, and locked by the locking nut 41 so that the abutting portion 35 is tightly abutted against a lower end face of the cutterhead body 1, thereby the each of the at least two installing shafts 3 is completely fixed.

In some embodiments, the abutting portion 35 is provided with an inner hexagonal groove 351, when the limiting plate 4 is locked by the locking nut 41, the inner hexagonal groove 351 on the abutting portion 35 is placed on a jig for fixing, and the locking nut 41 is locked by a spanner.

In some embodiments, a flange 6 is limit-disposed in the center shaft 2, an upper end of the flange 6 is provided with a step 61 aligned to the upper end of the center shaft 2, and the step 61 is upwards protruded and provided with a positioning convex ring 62 cooperated with a center of the limiting plate 4, through the above installation, the limiting plate is conveniently radially positioned, so that installation of the limiting plate 4 is more convenient.

In some embodiments, an end, away from the corresponding installing shaft 3 in the at least two installing shafts 3, of the first blade 31 is downwards inclined disposed, so that enough space is kept between the first blade 31 and a housing 5, and wood is conveniently adequately cut by the first blade 31. An end, away from the corresponding installing shaft 3, of the second blade 33 is downwards inclined disposed, so the wood positioned in the center of the cutterhead body 1 is conveniently taken out from an upper end of the housing 5, and a blocking phenomenon caused by wood stacking is avoided, at the same time, because the second blade 33 is downwards inclined disposed, a cutting force of the second blade 33 to the wood is improved, thereby the wood is convenient to cut adequately by the second blade 33.

In some embodiments, a third blade 42 detachably disposed is further included, the third blade 42 is positioned between the limiting plate 4 and a locking nut 41, an end, stretched out of the limiting plate 4, of the third blade 42 is upwards inclined disposed, the third blade 42 and the first blade 31 are staggered arrangement, there are 4 installing shafts 3 in some embodiments of the disclosure, through the above installation, a cutting gradation of the cutterhead assembly is distinct, and the effect of cutting a material is better.

In some embodiments, the cutterhead body 1 is provided with a plurality of baffles 7 which are radially disposed, at least one baffle 7 is disposed between the adjacent installing shafts 3, a lower end of each of the plurality of baffles 7 is provided with two convex ribs 71 which are disposed at intervals, the cutterhead body 1 is provided with rectangular grooves 12 cooperated with the two convex ribs 71, the each of the plurality of baffles 7 and the cutterhead body 1 are integrally connected through welding or glue, through providing the baffles 7, a gap between the cutterhead body 1 and the housing 5 is reduced, and a function of adequately cutting is achieved.

In some embodiments, a lower end of the cutterhead body 1 is provided with a fourth blade 13, the cutterhead body 1 is provided with a strip-shaped groove 14, and the strip-shaped groove 14 is disposed corresponding to a cutting notch of the fourth blade 13, through the above installation, a part of broken wood cut by the fourth blade 13 is discharged through the strip-shaped groove 14, thereby the broken wood is avoided from being stacked at the cutting notch of the fourth blade 13 so that a cutting effect of the fourth blade 13 is affected.

In some embodiments, a part, away from the cutting notch, of the fourth blade 13 is provided with a contacting portion 15, the contacting portion 15 is fixedly connected to the cutterhead body 1, through providing the contacting portion 15, a contacting area between an end wall of the fourth blade 13 and the cutterhead body 1 is increased, on one aspect, the fourth blade 13 is conveniently installed, on the other aspect, an installing effect of the fourth blade 13 is stronger through increasing the contacting area.

In some embodiments, a shaft hole 21 is disposed in the center shaft 2, the shaft hole 21 is provided with a key groove 22, through providing the key groove 22, the cutterhead assembly is installed on a crank shaft of the branch grinder for working.

A working principle of some embodiments of the disclosure is as follows.

Based on the cutterhead assembly of the branch grinder, there is the gap between the limiting plate 4 and the upper end of the first blade 31, the first blade 31 and the second blade 33 are in clearance fit with the corresponding installing shaft 3 so that the first blade 31 and the second blade 33 are circumferentially rotated in 360 degrees relative to the installing shaft 3, through the above installation, in a circumferential rotating process of the first blade 31 and the second blade 33, a shredded material can be taken out from the center of the cutterhead body 1, and a problem that material blockage is caused to affect a cutting effect of the cutterhead assembly due to the material is stacked in the center of the cutterhead body 1 is avoided; an end, relative to the installing shafts 3, of the first blade 31 is downwards inclined disposed, so that enough space is kept between the first blade 31 and the housing 5, and the material is adequately cut by the first blade 31, the third blade 42 and the first blade 31 are stagger disposed, so that the cutting gradation of the cutterhead assembly is distinct, the material is cut in different directions, the material is more uniformly cut and the effect is better; and the third blade 42 is detachably installed with the limiting plate 4, so the third blade 42 damaged is conveniently replaced.

The above are only some implementation modes of the disclosure, so any equivalent changes or modifications made according to the structures, features and principles described in a scope of the disclosure patent application shall fall within the scope of the disclosure patent application.

What is claimed is:

1. A cutterhead assembly of a branch grinder, comprising a cutterhead body (1), a center shaft (2) disposed in a center of the cutterhead body (1) and at least two installing shafts (3) circumferentially distributed by using the center shaft (2) as an axis, wherein each of the at least two installing shafts (3) is successively provided with a limiting plate (4), a first blade (31), a first bush (32), a second blade (33) and a second bush (34) from top to bottom, the first blade (31) and the second blade (33) are in clearance fit with a corresponding installing shaft (3) in the at least two installing shafts (3), and the first blade (31) and the second blade (33) can be rotated in 360 degrees around the corresponding installing shaft (3), a center of the limiting plate (4) is positioned at an upper end of the center shaft (2) and there is a gap between the limiting plate (4) and an upper end of the first blade (31), and an outer end of the limiting plate (4) is stretched into the installing shafts (3) and fixed.

2. The cutterhead assembly of the branch grinder as claimed in claim 1, wherein an end, away from the corresponding installing shaft (3), of the first blade (31) is downwards inclined disposed.

3. The cutterhead assembly of the branch grinder as claimed in claim 1, wherein an end, away from the corresponding installing shaft (3), of the second blade (33) is downwards inclined disposed.

4. The cutterhead assembly of the branch grinder as claimed in claim 1, wherein the cutterhead assembly of the branch grinder further comprises a third blade (42) detachably installed, the third blade (42) is positioned at an upper end of the limiting plate (4), and an end, stretched out of the limiting plate (4), of the third blade (42) is upwards inclined disposed.

5. The cutterhead assembly of the branch grinder as claimed in claim 4, wherein the third blade (42) and the first blade (31) are crossed disposition.

6. The cutterhead assembly of the branch grinder as claimed in claim 5, wherein the cutterhead body (1) is provided with a plurality of baffles (7) which are radially disposed, and at least one baffle (7) in the a plurality of baffles is disposed between adjacent installing shafts (3).

7. The cutterhead assembly of the branch grinder as claimed in claim 6, wherein a lower end of each of the plurality of baffles (7) is provided with two convex ribs (71) which are disposed at intervals, the cutterhead body (1) is provided with rectangular grooves (12) cooperated with the two convex ribs (71).

8. The cutterhead assembly of the branch grinder as claimed in claim 1, wherein a flange (6) is limit-installed in the center shaft (2), an upper end of the flange (6) is provided with a step (61) aligned to the upper end of the center shaft (2), and the step (61) is upwards protruded and provided with a positioning convex ring (62) cooperatively installed with a center of the limiting plate (4).

9. The cutterhead assembly of the branch grinder as claimed in claim 1, wherein a fourth blade (13) is disposed at a lower end of the cutterhead body (1), the cutterhead body (1) is provided with a strip-shaped groove (14), and the strip-shaped groove (14) is disposed corresponding to a cutting notch of the fourth blade (13).

10. The cutterhead assembly of the branch grinder as claimed in claim 1, wherein a shaft hole (21) is disposed in the center shaft (2), and the shaft hole (21) is provided with a key groove (22).
